(19) United States
(12) Patent Application Publication
(10) Pub. No.: US 2015/0088762 A1
(43) Pub. Date: Mar. 26, 2015

(54) IMPLEMENTING A BARGAINING STRATEGY BETWEEN TEAMS WITH MAJORITY VOTING

(71) Applicant: International Business Machines Corporation, Armonk, NY (US)

(72) Inventors: Wesley Michael Gifford, New Canaan, CT (US); Ankur Mani, Cambridge, MA (US); Anshul Sheopuri, White Plains, NY (US)

(73) Assignee: International Business Machines Corporation, Armonk, NY (US)

(21) Appl. No.: 14/043,916

(22) Filed: Oct. 2, 2013

Related U.S. Application Data
(63) Continuation of application No. 14/032,801, filed on Sep. 20, 2013.

(51) Int. Cl. G06Q 30/06

(52) U.S. Cl. CPC G06Q 30/0611
USPC 705/80

(57) ABSTRACT

A method of implementing a bargaining strategy includes receiving a first plurality of attributes corresponding to team members of a first team, and a second plurality of attributes corresponding to team members of a second team. The two teams participate in a bargaining process and each team bargains pursuant to a majority rule. The method includes determining at least one critical first team member from the first team using the first plurality of attributes, and at least one critical second team member from the second team using the second plurality of attributes. The at least one critical first and second team members are determinative of an agreeable outcome of the bargaining process. The method includes generating suggested bargaining terms likely to result in the agreeable outcome of the bargaining process between the first and second teams according to the at least one critical first and second team members.

### CROSS-REFERENCE TO RELATED APPLICATIONS

This application is a Continuation application of U.S. application Ser. No. 14/032,801, filed on Sep. 20, 2013, the disclosure of which is incorporated by reference herein in its entirety.

### BACKGROUND

1. Technical Field

Exemplary embodiments of the present invention relate to a system and method of bargaining between teams with majority voting, and more specifically, to a system and method of receiving input regarding the attributes of two teams, using this input to determine a bargaining procedure likely to result in an agreeable outcome, and outputting suggested bargaining terms based on the bargaining procedure determination.

2. Discussion of Related Art

When two teams (e.g., a team of buyers and a team of sellers) engage in a bargaining/negotiation process in which each team's decision is made under a majority rule, different attributes of team members on each team influence the ability to reach an agreeable outcome. For example, attributes such as the valuation of the agreement being negotiated, the patience regarding the timing of finalizing the agreement being negotiated, and the voting weights of each team member may influence the ability to reach an agreeable outcome.

### SUMMARY

According to an exemplary embodiment of the present invention, a method of implementing a bargaining strategy includes receiving a first plurality of attributes corresponding to team members of a first team, and a second plurality of attributes corresponding to team members of a second team, wherein the first and second teams participate in a bargaining process and each team bargains pursuant to a majority rule, determining at least one critical first team member from the first team using the first plurality of attributes, and at least one critical second team member from the second team using the second plurality of attributes, wherein the at least one critical first and second team members are determinative of an agreeable outcome of the bargaining process, and generating suggested bargaining terms likely to result in the agreeable outcome of the bargaining process between the first and second teams according to the at least one critical first and second team members.

In an exemplary embodiment, the first and second plurality of attributes include a valuation score representing an importance of reaching the agreeable outcome to each respective team member, a patience score representing a willingness of each respective team member to reach the agreeable outcome at a subsequent time, and a voting weight representing a voting influence of each respective team member during the bargaining process.

In an exemplary embodiment, a sum of the voting weights for each team is one.

In an exemplary embodiment, the suggested bargaining terms are agreeable to the critical first and second team members, and are not agreeable to an entirety of team members of the first and second teams.

In an exemplary embodiment, the method further includes simulating a bargaining process between only the at least one critical first and second team members, wherein generating the suggested bargaining terms likely to result in the agreeable outcome of the bargaining process between the first and second teams is based on a simulated result of the simulated bargaining process.

In an exemplary embodiment, the first team includes a team of buyers of a product or a service, and the second team includes a team of sellers of the product or the service.

In an exemplary embodiment, the generated suggested bargaining terms include a suggested price of the product or service likely to result in the agreeable outcome between the first and second teams.

In an exemplary embodiment, the method further includes generating a first price matrix indicating a maximum price of the product or service acceptable to each buyer of the first team relative to each seller of the second team, generating a second price matrix indicating a minimum price of the product or service acceptable to each seller of the second team relative to each buyer of the first team, generating a potential critical seller list by determining a lowest price resulting in a weighted majority of approval of sellers of the second team for each row in the first price matrix, generating a potential critical buyer list by determining a highest price resulting in a weighted majority of approval of buyers of the first team for each column in the second price matrix, selecting the at least one critical first and second team members based on a comparison of the potential critical buyers and the potential critical sellers, and generating the suggested bargaining terms according to the selected at least one critical first and second team members.

In an exemplary embodiment, the suggested bargaining terms include a final maximum price likely to result in the agreeable outcome between the first and second teams, and a final minimum price likely to result in the agreeable outcome between the first and second teams.

In an exemplary embodiment, the majority rule of the first and second teams is different.

In an exemplary embodiment, the majority rule of at least one of the first and second teams requires unanimity.

In an exemplary embodiment, the method further includes determining a surplus within at least one of the first and second teams when intra-team transfers are permitted within the at least one of the first and second teams, and distributing the surplus among at least two team members of the at least one of the first and second teams.

In an exemplary embodiment, an entirety of the surplus is given to a single team member of the at least one of the first and second teams, wherein the single team member has a highest patience score among the team members of the at least one of the first and second teams.

According to an exemplary embodiment of the present invention, a method of implementing a bargaining strategy includes receiving a first plurality of attributes corresponding to team members of a first team, and a second plurality of attributes corresponding to team members of a second team, wherein the first and second teams participate in a bargaining process and each team bargains pursuant to a majority rule, generating at least one simulated critical first team member corresponding to the first team based on a weighted average of a first attribute from among the first plurality of attributes of every team member of the first team, generating at least one simulated critical second team member corresponding to the second team based on a weighted average of a first attribute from among the second plurality of attributes of every team member of the second team, wherein the at least one simulated critical first and second team members are determinative of an agreeable outcome of the bargaining process, and generating suggested bargaining terms likely to result in the agreeable outcome of the bargaining process between the first and second teams according to the at least one simulated critical first and second team members.

According to an exemplary embodiment of the present invention, a method of implementing a bargaining strategy includes receiving a first plurality of attributes corresponding to team members of a first team, and a second plurality of attributes corresponding to team members of a second team, wherein the first and second teams participate in a bargaining process and each team bargains pursuant to a majority rule, generating a first price matrix indicating a maximum value acceptable to each team member of the first team relative to each team member of the second team, generating a second price matrix indicating a minimum value acceptable to each team member of the second team relative to each team member of the first team, generating a potential first critical team member list, including a plurality of potential first critical team members, by determining a highest price resulting in a weighted majority of approval of the team members of the first team for each column in the second price matrix, generating a potential second critical team member list, including a plurality of potential second critical team members, by determining a lowest value resulting in a weighted majority of approval of the team members of the second team for each row in the first price matrix, selecting at least one first critical team member from among the plurality of first potential critical team members, and at least one second critical team member from among the plurality of second potential critical team members, based on a comparison of the potential first critical team members and the potential second critical team members, wherein the at least one first and second critical team members are determinative of an agreeable outcome of the bargaining process, and generating suggested bargaining terms according to the selected at least one first and second critical team members likely to result in the agreeable outcome of the bargaining process.

### BRIEF DESCRIPTION OF THE DRAWINGS

The above and other features of the present invention will become more apparent by describing in detail exemplary embodiments thereof with reference to the accompanying drawings, in which:

FIG. 1 is a diagram showing an overview of a bargaining determination system, according to an exemplary embodiment of the present invention.

FIG. 2 is a diagram showing an overview of a bargaining determination system, according to an exemplary embodiment of the present invention.

FIG. 3 shows an example of a data structure created and stored in a bargaining determination system, according to an exemplary embodiment of the present invention.

FIG. 4. shows exemplary price matrices and corresponding critical seller and buyer lists, according to an exemplary embodiment of the present invention.

FIG. 5 is a flowchart illustrating a method of determining a critical buyer and a critical seller, and a maximum price and a minimum price, using the matrices and critical buyer/seller lists shown in FIG. 4, according to an exemplary embodiment of the present invention.

FIGS. 6 to 8 are exemplary graphs illustrating changes in the suggested bargaining terms likely to result in an agreeable outcome that are output in exemplary embodiments in response to a change in the attributes of a team member.

FIG. 9 illustrates a computer system for implementing aspects of exemplary embodiments of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

According to exemplary embodiments, a system and method of implementing a bargaining strategy between teams with majority voting is provided. More specifically, a system and method of receiving input regarding the attributes of two teams, using this input to determine a bargaining procedure likely to result in an agreeable outcome, and outputting suggested bargaining terms based on the bargaining procedure determination, is provided. For example, during a bargaining process, two teams, for example, a first team of sellers and a second team of buyers, may each implement majority voting during the bargaining process. In this case, the decision of whether to reach an agreement with the opposing team may be made under the majority rule (e.g., a majority vote may be required within each team to reach an agreement). Different attributes of each team, and different attributes for each member of each team, have an outcome on reaching an agreeable outcome, and utilizing these attributes may assist in achieving the agreeable outcome.

The teams involved in the bargaining process may be heterogeneous teams. For example, members of each team member may have different attributes relating to their willingness and/or ability to reach an agreement with the opposing team. Such attributes may include, for example, the valuation of the agreement being negotiated (e.g., the amount of value/importance of the agreement to each respective team member), patience regarding the timing of finalizing the agreement being negotiated (e.g., a willingness to wait for a more favorable agreement), and voting weights of each team member (e.g., the amount of influence each team member has in the bargaining process). That is, the heterogeneity of the teams may be with relation to the value of a good or service, the voting weight of the respective members, and/or the respective patience of the members. These attributes, which may be used as parameters during the bargaining process according to exemplary embodiments, may include a degree of uncertainty. Exemplary embodiments described herein provide a system and method to account for this degree of uncertainty. In addition, different teams may include different majority requirements.

Herein, the terms bargaining and negotiating may be used interchangeably, and the terms teams and groups may be used interchangeably.

For convenience of explanation, exemplary embodiments are described herein with reference to a first team including buyers of a product or service, and a second team including sellers of a product or service. However, it is to be understood that exemplary embodiments are not limited thereto. For example, exemplary embodiments may be utilized with any two groups in which majority voting among each group is used to reach an outcome, and in which team members of each group are defined by respective attributes.

A number of examples illustrating exemplary embodiments of the present invention will be described herein. In these examples, it is assumed that X={x₁, . . . xₙ} is a team of buyers, and Y={y₁, . . . yₘ} is a team of sellers. Herein, xᵢ denotes the i^{th} buyer, yⱼ denotes the t^{h} seller, n denotes the total number of buyers on the buying team, and m denotes the total number of sellers on the selling team. The value of the good or service to buyer xᵢ is Vₓᵢ, and the value of the good or service to seller yⱼ is V_{yj}. An agreeable outcome occurs in a bargaining scenario between a buyer and seller when the buyer values the good or service being offered at a level greater than or equal to the seller's valuation of the good or service. Thus, bargaining occurs when Vₓᵢ≧V_{yj}.

Exemplary embodiments of the present invention described herein may be utilized in a bargaining scenario in which each team reaches a decision by utilizing a majority voting rule. The majority voting rule may vary. For example, in some scenarios, a simple majority rule may be implemented, while in others, unanimous agreement may be required. For example, in one scenario, to reach a decision, at least a fraction w_{X} of buyers must vote yes for the majority, and at least a fraction w_{Y} of sellers must vote yes for the majority. Exemplary embodiments capable of providing suggested bargaining terms in different scenarios are described herein.

During the bargaining process, alternating offers are typically presented by the teams involved. For example, each team may alternatingly offer a price for the good or service to the other team. If a team accepts an offer, the good or service is sold to the buyer team, and the agreed-upon price is paid to the selling team. If a team does not accept an offer, the team may collectively offer a price to the other team in the next round of bargaining. A number of attributes corresponding to each team member on each team influences the bargaining process, and has an impact on reaching an agreeable outcome. Exemplary embodiments of the present invention leverage these attributes to provide an output including suggested bargaining terms likely to result in an agreeable outcome.

Exemplary embodiments described herein utilize team member attributes including a valuation score V, a patience score δ, and a voting weight w. However, it is to be understood that exemplary embodiments are not limited to utilizing only these attributes. The valuation score V of each team member represents the value placed on the agreement being negotiated (which is in turn based on each team member's perceived cost of acquiring or providing the good or service being negotiated). For example, the valuation score V of each team member corresponds to the value/importance to that team member in regard to reaching an agreeable outcome. The patience score δ of each team member represents the importance of the timing of finalizing the agreement being negotiated. For example, the patience score δ of each team member corresponds to the willingness, to that team member, to wait for a more favorable agreement than the one currently being offered. That is, the patience score δ represents a team member's willingness of reaching an agreement later rather than sooner. The voting weight w of each team member (e.g., w_{α}) represents the amount of influence that team member has during the bargaining process. For example, team members having a high position within a company may have a higher voting weight w than team members having a lower position within the company.

The buyers and sellers on each team may be arranged in order (e.g., ascending or descending order) with respect to their voting weights w, or with respect to other attributes. The sum of the weights of all members in a team may be 1. Each buyer and seller may discount the future individually with a discount rate of d_{α} for the agent α. Therefore, if an agreement between the two teams is made at stage t on a price P, the utility for the buyer xᵢ is δₓᵢ (Vₓᵢ−P)^{t}, and the utility for the seller yⱼ is δ_{yj}(P−Vₓᵢ)^{t}. For example, every buyer and seller may place a different value on the utility of the negotiation succeeding now or at a later stage. In this sense δₓᵢ and δ_{yj} capture the patience (willingness to wait) for the negotiation to go through.

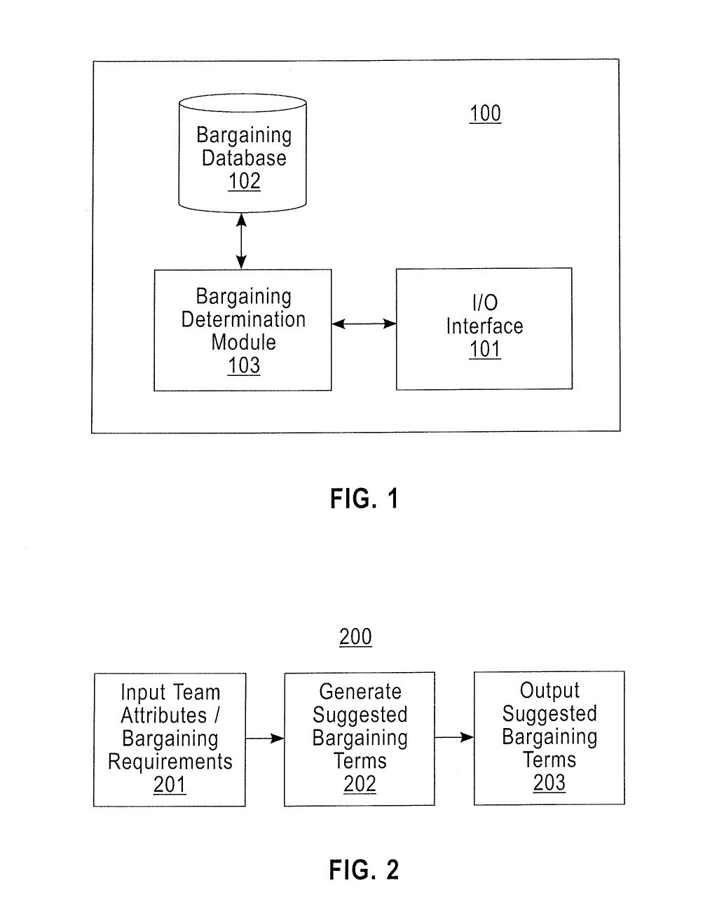

FIG. 1 shows an overview of a bargaining determination system, according to an exemplary embodiment of the present invention.

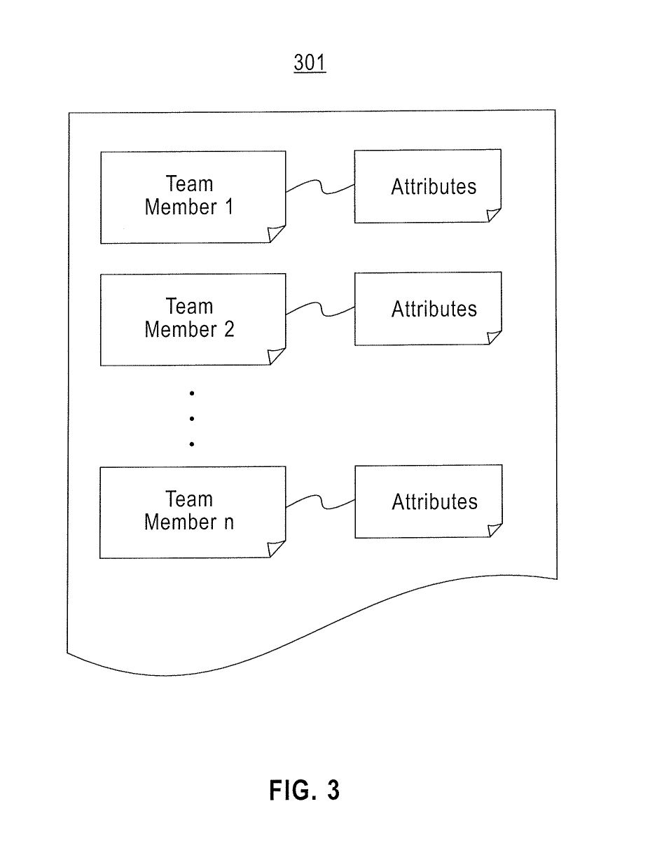

As described above, team attributes corresponding to team members of two teams involved in a bargaining process are utilized to determine suggested bargaining terms likely to result in an agreeable outcome. These team attributes may be input to a bargaining determination system 100 via an input/output (I/O) interface 101. In exemplary embodiments, in addition to inputting team attributes, bargaining requirements relating to the bargaining process may additionally be input. A bargaining determination module 103 may create data structure(s) based on the input, and may store these data structure(s) in a bargaining database 102. An exemplary data structure is shown in FIG. 3. The bargaining determination module 103 may implement various methods according to exemplary embodiments of the present invention, as described herein, to generate suggested bargaining terms likely to result in an agreeable outcome. The suggested bargaining terms may be, for example, a suggested price likely to result in an agreement between the two teams. The generated suggested bargaining terms may be output via the I/O interface 101.

FIG. 2 shows an overview of a bargaining determination system 200, according to an exemplary embodiment of the present invention. Referring to FIG. 2, team attributes (and in some embodiments, bargaining requirements) are input to the bargaining determination system 200 at 201, suggested bargaining terms are generated at 202, and the suggested bargaining terms are output at 203.

FIG. 3 shows an example of a data structure 301 created and stored in a bargaining determination system, according to an exemplary embodiment of the present invention. Referring to FIG. 3, a data structure 301 may include a listing of team members linked to their respective attributes, as described above. A single data structure may be created for each team, for both teams, or for each member.

Exemplary embodiments of the present invention may be utilized with bargaining scenarios involving no intra-team transfers, as well as bargaining scenarios involving costless intra-team transfers.

Referring to bargaining with no intra-team transfers (e.g., bargaining scenarios in which no intra-team transfers are present), team members make voting decisions based on their own respective valuation of the good or service, and the valuation of other members and the benefit of the deal is not shared. Generating suggested bargaining terms in bargaining scenarios with no intra-team transfers, according to exemplary embodiments, include determining the members that constitute the majority on both teams that will agree to a deal, determining the critical members on both teams, and generating the suggested bargaining terms based on a bargaining process (e.g., a simulated bargaining process) between the critical members. Generating the suggested bargaining terms based specifically on the critical members (e.g., determining bargaining terms specifically agreeable to the critical members) allows for the generation of bargaining terms likely to be acceptable to the majority on each team, since any agreeable outcome reached by the critical members will likely be acceptable to the majority on each team. Thus, in exemplary embodiments, once the critical members of the teams are determined, only the critical members are taken into consideration when generating suggested bargaining terms. Generating the suggested bargaining terms may include determining the price(s) to offer to the teams based on the critical members, and outputting these determined price(s). Critical members, and the impact of critical members on determining suggested bargaining terms, are discussed in further detail below.

Referring to bargaining with intra-team transfers (e.g., bargaining scenarios in which intra-team transfers are present), team members on each team are permitted to share the benefit of a deal among themselves, without any cost of sharing. For example, members of a team may make transfers to other members on their team to persuade the other members to vote for a particular offer. Exemplary embodiments utilized in bargaining scenarios with intra-team transfers include determining the most favorable manner in which to distribute the benefits of a deal within the team. This process results in the largest benefit of the deal for the entire team, regardless of the decision making process of the other team. Further, exemplary embodiments include determining the price(s) to offer that will be acceptable to both teams according to the determined distribution of benefits.

Bargaining with No Intra-Team Transfers

In exemplary embodiments in which intra-team transfers are not present, in any form of heterogeneity (e.g., heterogeneity relating to voting weight w, patience δ, and/or valuation V), a critical buyer and a critical seller exist. In this case, the bargaining outcome is determined by the bargaining between the critical buyer and the critical seller. For example, if the one critical buyer and the one critical seller independently bargained with each other, a majority of the buyers and sellers would agree to the price agreed upon by the critical buyer and seller. Thus, exemplary embodiments provide a system and method of generating and outputting suggested bargaining terms (e.g., a price) likely to result in an agreeable outcome based on the critical pair (e.g., the critical buyer and the critical seller). For example, exemplary embodiments may simulate a bargaining process between the critical buyer and critical seller, and generate and output suggested bargaining terms for the first and second teams based on the simulation results. Exemplary embodiments of generating suggested bargaining terms in a bargaining scenario in which intra-team transfers are not present are described herein.

The critical buyer is represented by x* and the critical seller is represented by y*. Further, the maximum price that the critical buyer x* is willing to accept when bargaining independently with the critical seller y* is represented by P*, and the minimum price that the critical seller y* is willing to accept when bargaining independently with the critical buyer x* is represented by P^{∘}. For example, the team of buyers will accept any price less than or equal to P*_{x*y*}, and will offer the price P^{∘}_{x*y*}. The team of sellers will accept any price greater than or equal to P^{∘}_{x*y*}, and will offer the price P*_{x*y*}. In this case, the buyer/seller with the highest/lowest valuation will receive the largest surplus. The maximum price P* and minimum price P^{∘} may be represented as:

$${P}^{*} = \frac{( 1 - {δ}_{{x}^{*}} )}{( 1 - {δ}_{{y}^{*}} {δ}_{{x}^{*}} )} {V}_{{x}^{*}} + \frac{{δ}_{{x}^{*}} ( 1 - {δ}_{{y}^{*}} )}{( 1 - {δ}_{{y}^{*}} {δ}_{{x}^{*}} )} {V}_{{y}^{*}}$$

$${P}^{∘} = \frac{( 1 - {δ}_{{y}^{*}} )}{( 1 - {δ}_{{y}^{*}} {δ}_{{x}^{*}} )} {V}_{{y}^{*}} + \frac{{δ}_{{y}^{*}} ( 1 - {δ}_{{x}^{*}} )}{( 1 - {δ}_{{y}^{*}} {δ}_{{x}^{*}} )} {V}_{{x}^{*}}$$

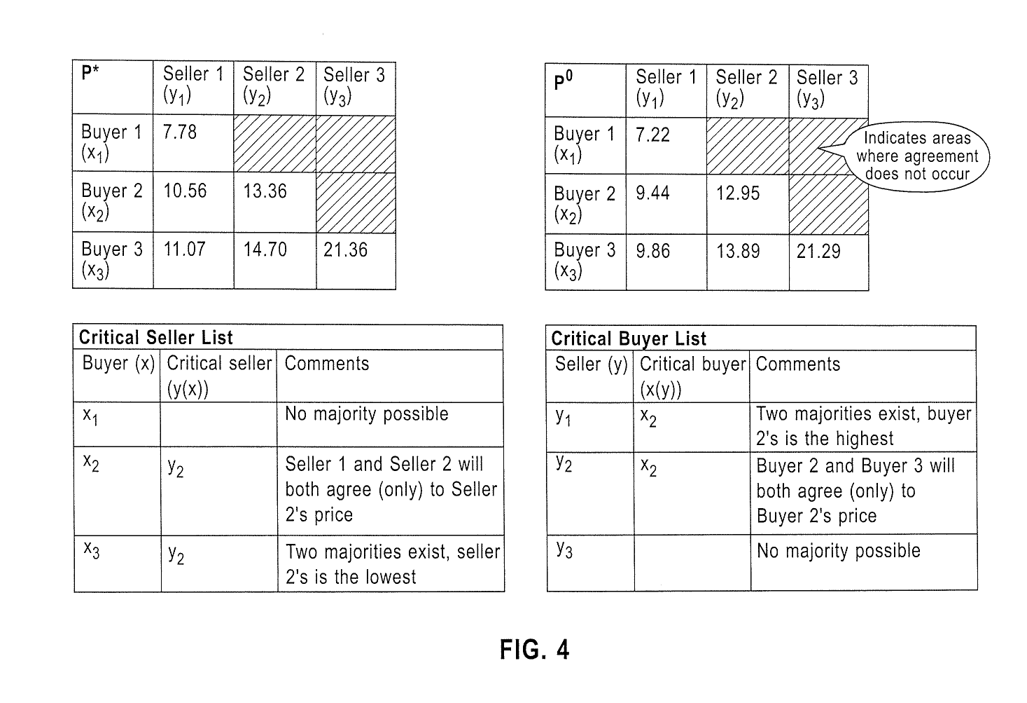

In the above equations, P* may be expressed as a price matrix consisting of elements P*_{xi,yj}, and P^{∘} may be expressed as a price matrix consisting of elements P^{∘}_{xi,yj}. That is, matrices P* and P^{∘} may be created taking the i^{th} buyer and the j^{th} seller into consideration (e.g., by replacing x with xᵢ and y with yⱼ in the above equations). Exemplary price matrices corresponding to P* and P^{∘}, as well as corresponding critical seller and buyer lists, are shown in FIG. 4. As described above, P* corresponds to the highest price that will be accepted by all buyers on the buying team (e.g., a maximum acceptable price), and P^{∘} corresponds to the lowest price that will be accepted by all sellers on the selling team (e.g., a minimum acceptable price). The elements of the matrices P* and P^{∘} represent the pairwise prices between the i^{th} buyer (e.g., the rows in FIG. 1) and the j^{th} seller (e.g., the columns in FIG. 1). The price matrices and critical seller and buyer lists shown in FIG. 4 may be generated by the bargaining determination module 103 of FIG. 1, and stored in the bargaining database 102 of FIG. 1. In addition to storing and utilizing the price matrices and critical seller and buyer lists to generate suggested bargaining terms, exemplary embodiments may further output the price matrices and critical seller and buyer lists via the I/O interface 101.

Referring to FIG. 4, a team of sellers includes three sellers (seller y₁, seller y₂, and seller y₃), and a team of buyers includes three buyers (buyer x₁, buyer x₂ and buyer x₃). In the current example, the first through third sellers y₁ through y₃ have respective valuation scores of 5, 12 and 21, respective patience scores of 0.8, 0.7 and 0.8, and have equal voting weights of 1. Thus, a ⅔ majority is required for the selling team. The first through third buyers x₁ through x₃ have respective valuation scores of 10, 15 and 22, respective patience scores of 0.8, 0.8 and 0.9, and have equal voting weights of 1. Thus, a ⅔ majority is also required for the buying team. It is to be understood that although both teams in the current example have identical majority requirements, exemplary embodiments are not limited thereto. For example, exemplary embodiments may be utilized with two teams having different majority requirements. In the matrices P* and P^{∘} as shown in FIG. 4, the areas in which an agreeable outcome does not occur do not include price values, and are shaded.

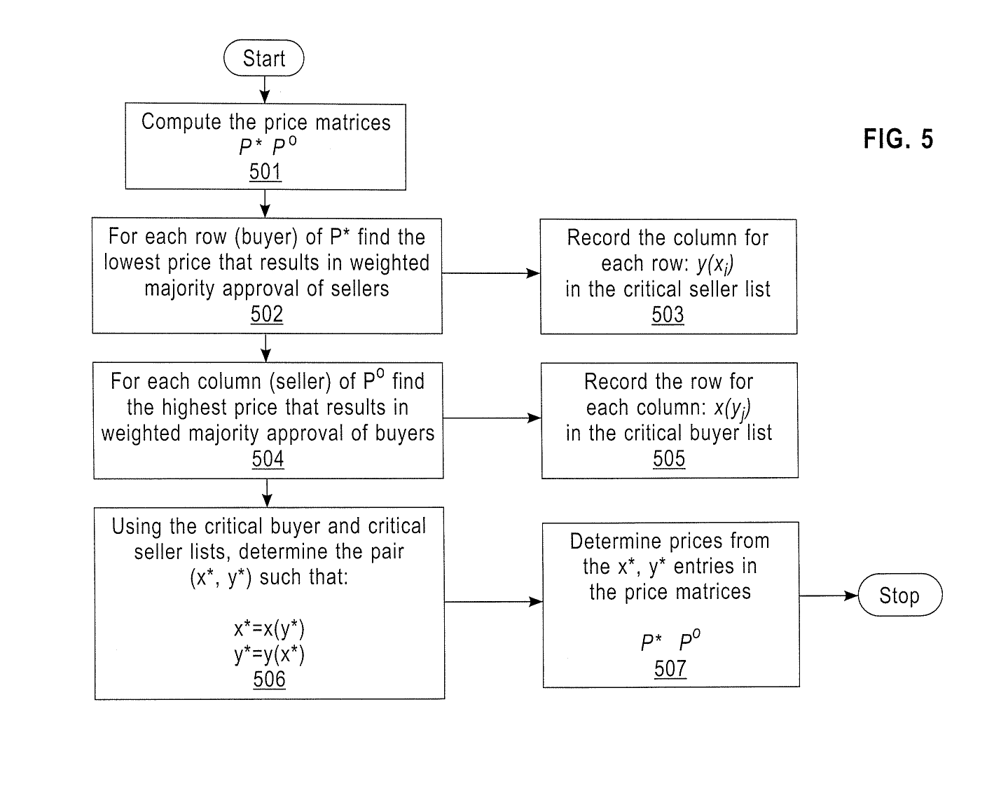

FIG. 5 is a flowchart illustrating a method of determining the critical buyer and the critical seller, and the maximum price P* and the minimum price P^{∘}, using the matrices and critical buyer/seller lists shown in FIG. 4, according to an exemplary embodiment of the present invention. The operations described with reference to FIG. 5 may be performed by the bargaining determination module 103 of FIG. 1 using data stored in the bargaining database 102 (e.g., the price matrices and critical lists shown in FIG. 4).

At operation 501 the price matrices corresponding to the maximum price P* and the minimum price P^{∘} are generated. At operation 502, for each row (e.g., for each buyer) of the P* matrix, the lowest price that results in a weighted majority of approval of sellers is determined. The column corresponding to each row (e.g., y(xᵢ)) is recorded in the critical seller list at operation 503. At operation 504, for each column (e.g., for each seller) of the P^{∘} matrix, the highest price that results in a weighted majority approval of buyers is determined. The row corresponding to each column (e.g., x(yⱼ)) is recorded in the critical buyer list at operation 505. At operation 506, the critical seller and critical buyer lists are utilized to determine the pair (x*, y*) such that x*=x(y*) and y*=y(x*). For example, the critical buyer and the critical seller may be determined based on a comparison of the critical seller list (which includes a listing of all potential critical sellers) and the critical buyer list (which includes a listing of all potential critical buyers). At operation 507, the maximum and minimum prices P* and P^{∘} are determined from the x*,y* entries in the price matrices.

Referring to the critical lists shown in FIG. 4, a buyer/seller overlap of (x₂, y₂) can be determined. Based on this overlap, referring to the P* and P^{∘} matrices of FIG. 4, the maximum and minimum prices may be determined to be P*=13.36 and P^{∘}=12.95. That is, the team of buyers will accept any prices less than or equal to P* (e.g., $13.36) and will offer the price P^{∘} (e.g., $12.95), and the team of sellers will accept any price greater than or equal to P (e.g., $12.95) and will offer the price P* (e.g., $13.36). Thus, the suggested bargaining terms generated and output may be P*=13.36 and P^{∘}=12.95, or may be a price between P*=13.36 and P^{∘}=12.95.

As described above, the teams may be heterogeneous teams, and heterogeneity may be with relation to different attributes of the team members. For example, heterogeneity among the teams may exist only in relation to the team members' respective valuations V, in relation to the team members' respective valuations V and voting weights w, and in relation to the team members' respective valuations V, voting weights w, and patience scores δ.

When heterogeneity exists only with respect to team members' respective valuations V, the critical buyer may be represented by x*=x_{n-N+1}, where n is the current buyer and N is the total number of buyers, and the critical seller may be represented by y*=y_{M}, where M is the total number of sellers.

As described above, the buyers and sellers on each team may be arranged in an ascending order or a descending order based on different attributes. In an exemplary embodiment in which the buyers and sellers are arranged in an ascending order based on their respective valuations V, when heterogeneity exists with respect to team members' respective valuations V and voting weights w, the critical buyer is represented by:

x*=x_{b}, where b=maxᵢ{i: Σ_{j≦i}wₓ_{ⱼ}<1−N/n},

and the critical seller is represented by:

y*=yₛ, where s=maxᵢ{i: Σ_{j≦i}wₓ_{ⱼ}≧1−M/m},

When the heterogeneity exists with respect to team members' respective valuations V, voting weights w, and patience scores δ, the critical buyer and the critical seller may be determined using an exhaustive search based on the bargaining outcomes for all buyer/seller pairs. Among all of the buyer/seller pairs, a buyer/seller pair exists for which a majority of buyers and a majority of sellers will approve the pair's prices. If all buyers and sellers are different, a unique pair exists. In the following, results are shown based on heterogeneity existing in the valuations V and patience scores δ, however, the results shown herein are qualitatively similar in a scenario in which the voting weights w are not the same.

Within bargaining scenarios in which no intra-team transfers are present, different types of majorities may be required to reach an agreement. For example, for certain teams, reaching an agreeable outcome may require unanimous agreement, and for other teams, some majority may be required. Exemplary embodiments may be utilized in scenarios in which both teams require unanimous agreement, both teams require a majority agreement, and the teams respectively require a unanimous agreement and a majority agreement.

Unanimous Agreement Required when Bargaining with No Intra-Team Transfers

When unanimous agreement is required, for an agreement to be reached, all buyers must value the good or service more than all sellers. In this scenario, the selling team offers the highest price P* for all that will be accepted by all of the buyers, and the buying team offers the lowest price P^{∘} that will be accepted by all of the sellers. The maximum price that the buyers will accept may be represented as:

$${P}^{*} = {min}_{{x}_{i} ∈ X} {max}_{{y}_{j} ∈ Y} {P}_{{x}_{i} , {y}_{j}}^{*} , \qquad ( 1 )$$

where P*ₓ_{ᵢ}_{,y}_{ⱼ} is the maximum price that buyer xᵢ will accept while bargaining independently with seller yⱼ. The minimum price that the sellers will accept may be represented as:

$${P}^{∘} = {max}_{{y}_{i} ∈ Y} {min}_{{x}_{i} ∈ X} {P}_{{x}_{i} , {y}_{j}}^{∘} , \qquad ( 2 )$$

where P^{∘}ₓ_{ᵢ}_{,y}_{ⱼ} is the minimum price that seller yⱼ will accept while bargaining independently with buyer xᵢ.

Referring to equations (1) and (2) above, the critical buyer x* is the minimizer in equation (1), and the critical seller y* is the maximizer in equation (2). Thus, P*=P*_{x*,y*} and P^{∘}=P^{∘}_{x*,y*}. For all xᵢεX, P*ₓ_{ᵢ}_{,y*}≧P*, and for all yᵢεY, P^{∘}_{x*,y}_{ᵢ}≦P^{∘}.

When all team members have the same patience score, the critical buyer/seller pair is the pair having the lowest/highest valuation. When all team members have the same valuation, the critical team members are those having the highest patience scores.

Majority Agreement Required when Bargaining with No Intra-Team Transfers

When majority agreement is required, for an agreement to be reached, a majority of the buyers must value the good or service more than a majority of the sellers. In this scenario, the selling team offers the highest price P* for all that will be accepted by a majority of buyers, and the buying team offers the lowest price P^{∘} that will be accepted by a majority of sellers. The maximum price that the majority of buyers will accept may be represented as:

$${P}^{*} = {max}_{{X}^{′} ⊆ X : \vert {X}^{′} \vert \geq N} {min}_{{x}_{i} ∈ {X}^{′}} {min}_{{Y}^{′} ⊆ Y : \vert {Y}^{′} \vert \geq M} {max}_{{y}_{j} ∈ {Y}^{′}} {P}_{{x}_{i} , {y}_{j}}^{*}$$

The minimum price that the majority of sellers will accept may be represented as:

$$P° = {min}_{{Y}^{′} ⊆ Y : \vert {Y}^{′} \vert \geq M} {max}_{{y}_{j} ∈ Y} {max}_{{X}^{′} ⊆ X : \vert {X}^{′} \vert \geq N} {min}_{{x}_{i} ∈ X} {P}_{{x}_{i} , {y}_{j}}^{∘}$$

When all of the team members have the same patience score, the critical buyer/seller pair is the pair having the N^{th}/M^{th} lowest/highest valuation. When the valuation for all team members in the same team is the same, the critical members are the members having the N^{th}/M^{th} highest patience score.

Intra-Team Transfers Present

In exemplary embodiments in which intra-team transfers are present, the buyers/sellers with higher/lower values for the good or service make transfers to the buyers/sellers with lower/higher values to reach a unanimous agreement. In the presence of transfers, team members may agree to the transfers since a lower loss of the low/high valued buyers/sellers will occur relative to reaching a non-cooperative outcome in the absence of transfers. Utilization of costless transfers may improve the efficiency of the bargaining process. To reach an agreement using transfers, the majority of buyers/sellers must be able to offer an acceptable price to the other team, and the discounted average loss in the buyer/seller valuation must be at least/most as much as the discounted majority loss in the buyer/seller valuation. Thus, an agreeable outcome may be reached under the presence of transfers when an agreeable outcome is not reachable in the absence of transfers.

For example, in exemplary embodiments in which intra-team transfers are present, teams are permitted to transfer utilities or share benefits of the agreement among members, allowing the members to influence each other's voting decisions. Transfers may include a large number of combinations, resulting in a large number of possible outcomes. In contrast to exemplary embodiments in which intra-team transfers are not present, when transfers are present, the existence of a true critical buyer and critical seller may not exist. Rather, a simulated critical buyer and a simulated critical buyer may be generated. For example, the valuation and patience of a simulated critical buyer and critical seller is the weighted average of the valuations and patience of all buyers and sellers on the respective teams. Thus, in exemplary embodiments in which transfers between members of the same team are present, a simulated critical buyer and a simulated critical seller may be generated based on the weighted average of the valuations and/or patience of all buyers and sellers on the respective teams. Efficiency of the bargaining between the teams may be increased when the total surplus of both teams is maximized. For example, an agreeable outcome may only be reached if, and only if the average value of the good or service to the buying team is greater than the average cost of the good or service to the selling team. The efficiency of the strategy of a team regarding sharing surplus may be improved when that team's surplus is maximized given any strategy of the other team in the bargaining process.

In an exemplary scenario in which intra-team transfers are present, an agreeable outcome is only reached regarding a price pair P*, P^{∘} when the average valuation of the buyers is less than the average valuation of the sellers, for example, when:

$$\frac{1}{n} {\sum }_{{x}_{i} ∈ X} {V}_{{x}_{i}} < \frac{1}{m} {\sum }_{{y}_{j} ∈ Y} {V}_{{y}_{j}} .$$

When heterogeneity exists only with respect to team members' respective valuations V, an agreeable outcome occurs when:

$$\frac{1}{n} {\sum }_{i = 1}^{n} {V}_{{x}_{i}} \geq \frac{1}{m} {\sum }_{i = 1}^{m} {V}_{{y}_{i}} .$$

In this exemplary scenario, x* refers to a simulated critical buyer and y* refers to a simulated critical seller, each respectively having the following valuations:

$${V}_{{x}^{*}} = \frac{1}{n} {\sum }_{i = 1}^{n} {V}_{{x}_{i}}$$

$${V}_{{y}^{*}} = \frac{1}{m} {\sum }_{i = 1}^{m} {V}_{{y}_{i}}$$

In this case, the team of buyers will accept any price less than or equal to the maximum price P* and will offer the minimum price P^{∘}, and the team of sellers will accept any price greater than or equal to the minimum price P^{∘} and will offer the maximum price P*, where P* and P^{∘} are:

$${P}^{*} = \frac{( 1 - {δ}_{X} )}{( 1 - {δ}_{Y} {δ}_{X} )} {V}_{{x}^{*}} + \frac{{δ}_{X} ( 1 - {δ}_{Y} )}{( 1 - {δ}_{Y} {δ}_{X} )} {V}_{{y}^{*}}$$

$$P° = \frac{( 1 - {δ}_{Y} )}{( 1 - {δ}_{Y} {δ}_{X} )} {V}_{{y}^{*}} + \frac{{δ}_{Y} ( 1 - {δ}_{X} )}{( 1 - {δ}_{Y} {δ}_{X} )} {V}_{{x}^{*}}$$

Further, transfers are represented by:

tₓ_{ᵢ}=P*−δ_{X}P^{∘}−(1−δ)Vₓ_{ᵢ}.

Exemplary embodiments of the present invention may be utilized in bargaining scenarios in which transfers are made only in response to an offer from the other team. For example, transfers may not be utilized when making an initial offer, but may be utilized when a team is determining whether to accept or reject an offered price. In this case, an agreeable outcome is reached when the average valuation of the buyers is greater than the average valuation of the sellers, and when the majority of the buyers have higher valuations than the majority of the sellers. In this scenario, the sellers/buyers offer the price P*/P^{∘} that is acceptable to a majority of the sellers/buyers, and the buyers/sellers make transfers within their team such that all team members accept the price. In this case, the maximum and minimum prices P* and P^{∘} are:

$${P}^{*} = \frac{\frac{1}{n} {\sum }_{i = 1}^{n} {V}_{{x}_{i}} ( 1 - {δ}_{{x}_{i}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} + \frac{\frac{1}{n} {\sum }_{i = 1}^{n} {δ}_{{x}_{i}} \frac{1}{m} {\sum }_{j = 1}^{m} {V}_{{y}_{j}} ( 1 - {δ}_{{y}_{j}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} , \\ {t}_{{x}_{i}} = {δ}_{{x}_{i}} ( {V}_{{x}_{i}} - P° ) - ( {V}_{{x}_{i}} - {P}^{*} )$$

$$P° = \frac{\frac{1}{m} {\sum }_{j = 1}^{m} {V}_{{y}_{j}} ( 1 - {δ}_{{y}_{j}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} + \frac{\frac{1}{m} {\sum }_{j = 1}^{m} {δ}_{{y}_{j}} \frac{1}{n} {\sum }_{i = 1}^{n} {V}_{{x}_{i}} ( 1 - {δ}_{{x}_{i}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} , \\ {t}_{{y}_{j}} = {δ}_{{y}_{j}} ( {P}^{*} - {V}_{{y}_{j}} ) - ( P° - {V}_{{y}_{j}} )$$

Exemplary embodiments of the present invention may also be utilized in bargaining scenarios in which transfers are made both in response to an offer from the other team, as well as when making an initial offer. In this scenario, transfers may be made such that all team members with a team receive equal surplus, resulting in an efficient bargaining process. In this case, the whole team may work as one unit and team decisions are unanimous at every state. The critical buyer's valuation V̅_{X} and patience δ_{X}, and the critical seller's valuation V̅_{Y} and patience δ_{Y}, may be respectively expressed as:

$${\overline{V}}_{X} = \frac{1}{n} {\sum }_{n = 1}^{n} {V}_{{x}_{i}} , patience \text{:} {δ}_{X} = \frac{1}{n} {\sum }_{i = 1}^{n} {δ}_{{x}_{i}}$$

$${\overline{V}}_{Y} = \frac{1}{n} {\sum }_{i = 1}^{n} {V}_{{y}_{i}} , patience \text{:} {δ}_{Y} = \frac{1}{n} {\sum }_{i = 1}^{n} {δ}_{{y}_{i}}$$

The maximum price P* and the buying team's surplus C_{X} may be respectively expressed as:

$${P}^{*} = \frac{\frac{1}{n} {\sum }_{i = 1}^{n} {V}_{{x}_{i}} ( 1 - \frac{1}{n} {\sum }_{i = 1}^{n} {δ}_{{x}_{i}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} + \frac{\frac{1}{n} {\sum }_{i = 1}^{n} {δ}_{{x}_{i}} \frac{1}{m} {\sum }_{j = 1}^{m} {V}_{{y}_{j}} ( 1 - \frac{1}{m} {\sum }_{j = 1}^{m} {δ}_{{y}_{j}} )}{( 1 - \frac{1}{m} {\sum }_{j = 1}^{m} {δ}_{{y}_{j}} \frac{1}{n} {\sum }_{j = 1}^{n} {δ}_{{x}_{i}} )}$$

$${C}_{X} = \frac{1}{n} {\sum }_{i = 1}^{n} {V}_{{x}_{i}} - P°$$

The minimum price P^{∘} and the selling team's surplus C_{Y} may be respectively expressed as:

$$P° = \frac{\frac{1}{m} {\sum }_{i = 1}^{m} {V}_{{y}_{j}} ( 1 - \frac{1}{m} {\sum }_{i = 1}^{m} {δ}_{{y}_{j}} )}{( 1 - \frac{1}{m} {\sum }_{j = 1}^{m} {δ}_{{y}_{j}} \frac{1}{n} {\sum }_{i = 1}^{n} {δ}_{{x}_{i}} )} + \frac{\frac{1}{m} {\sum }_{i = 1}^{m} {δ}_{{x}_{i}} \frac{1}{n} {\sum }_{j = 1}^{n} {V}_{{y}_{j}} ( 1 - \frac{1}{n} {\sum }_{j = 1}^{n} {δ}_{{y}_{j}} )}{( 1 - \frac{1}{m} {\sum }_{j = 1}^{m} {δ}_{{y}_{j}} \frac{1}{n} {\sum }_{j = 1}^{n} {δ}_{{x}_{i}} )}$$

$${C}_{Y} = {P}^{*} - \frac{1}{m} {\sum }_{j = 1}^{m} {V}_{{y}_{j}}$$

According to an exemplary embodiment, an optimal transfer rule may be utilized when implementing intra-team transfers. Distributing all of the surplus to the team member having the highest patience score δ may result in the optimal manner of sharing a surplus, since the effective patience of the team is equal to the patience of the most patient team member. Accordingly, the optimal transfer rule distributes all of the team's surplus to the team member having the highest patience score δ. In this case, x*εarg maxₓ_{ᵢ}_{εX}δₓᵢ,y*εarg max_{y}_{ⱼ}_{εY}δ_{yj}. For each buyer xᵢ≠x*:

$${V}_{{x}_{i}} - {P}^{*} + {t}_{{x}_{i}}^{*} = {δ}_{{x}_{i}} ( {V}_{{x}_{i}} - P° + {t}_{{x}_{i}}^{°} ) = 0$$

$${V}_{{x}^{*}} - {P}^{*} + {t}_{{x}^{*}}^{*} = {δ}_{{x}^{*}} ( {V}_{{x}^{*}} - P° + {t}_{{x}^{*}}^{°} ) = n {δ}_{{x}^{*}} {C}_{X}$$

$$P° - {V}_{{y}_{j}} + {t}_{{y}_{j}}^{∘} = {δ}_{{y}_{j}} ( {P}^{*} - {V}_{{y}_{j}} + {t}_{{y}_{j}}^{*} ) = 0$$

$$P° - {V}_{{y}^{*}} + {t}_{{y}^{*}}^{∘} = {δ}_{{y}^{*}} ( {P}^{*} - {V}_{{y}^{*}} + {t}_{{y}^{*}}^{*} ) = m {δ}_{{y}^{*}} {C}_{Y}$$

$${\sum }_{{x}_{i} ∈ X} {t}_{{x}_{i}}^{*} = {\sum }_{{x}_{i} ∈ X} {t}_{{x}_{i}}^{∘} = {\sum }_{{y}_{j} ∈ Y} {t}_{{y}_{j}}^{*} = {\sum }_{{y}_{j} ∈ Y} {t}_{{y}_{j}}^{∘} = 0$$

Calculating an average all of buyers' surpluses yields:

$$\frac{1}{n} {\sum }_{{x}_{i} ∈ X} {V}_{{x}_{i}} - {P}^{*} = {δ}_{{x}^{*}} {C}_{X} = {δ}_{{x}^{*}} \frac{1}{n} ( {\sum }_{{x}_{i} ∈ X} {V}_{{x}_{i}} - P° )$$

Calculating an average all of sellers' surpluses yields:

$$\frac{1}{m} {\sum }_{{y}_{j} ∈ Y} {V}_{{y}_{j}} - P° = {δ}_{{y}^{*}} {C}_{Y} = {δ}_{{y}^{*}} \frac{1}{m} ( {\sum }_{{y}_{j} ∈ Y} {V}_{{y}_{j}} - {P}^{*} )$$

The critical buyer's valuation V̅_{X} and patience δ_{X}, and the critical seller's valuation V̅_{Y} and patience δ_{Y}, may be respectively expressed as:

$${\overline{V}}_{X} = \frac{1}{n} {\sum }_{i = 1}^{n} {V}_{{x}_{i}} , patience \text{:} {δ}_{X} = {max}_{i = 1}^{n} {δ}_{{x}_{i}}$$

$${\overline{V}}_{Y} = \frac{1}{n} {\sum }_{i = 1}^{n} {V}_{{y}_{i}} , patience \text{:} {δ}_{Y} = {max}_{i = 1}^{n} {δ}_{{y}_{i}}$$

Using these values, the maximum price P* and buying team's surplus C_{X}, and the minimum price P^{∘} and selling team's surplus C_{Y}, may be respectively calculated as:

$${P}^{*} = \frac{\frac{1}{n} {\sum }_{i = 1}^{n} {V}_{{x}_{i}} ( 1 - {δ}_{X} )}{( 1 - {δ}_{Y} {δ}_{X} )} + \frac{{δ}_{X} \frac{1}{m} {\sum }_{j = 1}^{m} {V}_{{y}_{j}} ( 1 - {δ}_{Y} )}{( 1 - {δ}_{Y} {δ}_{X} )}$$

$${C}_{X} = \frac{1}{n} {\sum }_{i = 1}^{n} {V}_{{x}_{i}} - P°$$

$$P° = \frac{\frac{1}{m} {\sum }_{j = 1}^{m} {V}_{{y}_{j}} ( 1 - {δ}_{Y} )}{( 1 - {δ}_{Y} {δ}_{X} )} + \frac{{δ}_{Y} \frac{1}{n} {\sum }_{i = 1}^{n} {V}_{{x}_{i}} ( 1 - {δ}_{X} )}{( 1 - {δ}_{Y} {δ}_{X} )}$$

$${C}_{Y} = {P}^{*} - \frac{1}{m} {\sum }_{j = 1}^{m} {V}_{{y}_{j}}$$

In this scenario, the transfers for each buyer xᵢ≠x* is t*ₓ_{ᵢ}=P*−Vₓ_{ᵢ}, t^{∘}ₓ_{ᵢ}=P^{∘}−Vₓ_{ᵢ}. The transfers for buyer x* is t*_{x*}=δ_{x*}C_{X}+P*−V_{x*}, and t^{∘}_{x*}=C_{X}+P^{∘}−V_{x*}. The transfers for each seller yⱼ≠y* is t*_{y}_{ⱼ}=V_{y}_{ⱼ}−P*, t^{∘}_{y}_{ⱼ}=V_{y}_{ⱼ}−P^{∘}. The transfers for seller y* is t*_{y*}=C_{Y}+V_{y*}−P*, and t^{∘}_{y*}=δ_{y*}C_{Y}+V_{x*}−P^{∘}.

Bargaining with Uncertainty

Bargaining scenarios do not always remain static. For example, changes in some team members' valuation and patience may occur, changes to the majority requirement may occur, and/or changes of the team members' voting weights may occur. Such changes can result in a change of the critical pair, and changes of the prices that are likely to lead to an agreeable outcome. For example, in certain bargaining scenarios, a critical member may change when a team member from the majority replaces the former critical member, or the majority may change when a critical member falls out of the majority. As a result, prices that will lead to an agreeable outcome, and thus, the suggested bargaining terms likely to result in an agreeable outcome that are generated and output in exemplary embodiments, may continuously change. Further, the majority may incur multiple changes at the same time, or at substantially the same time.

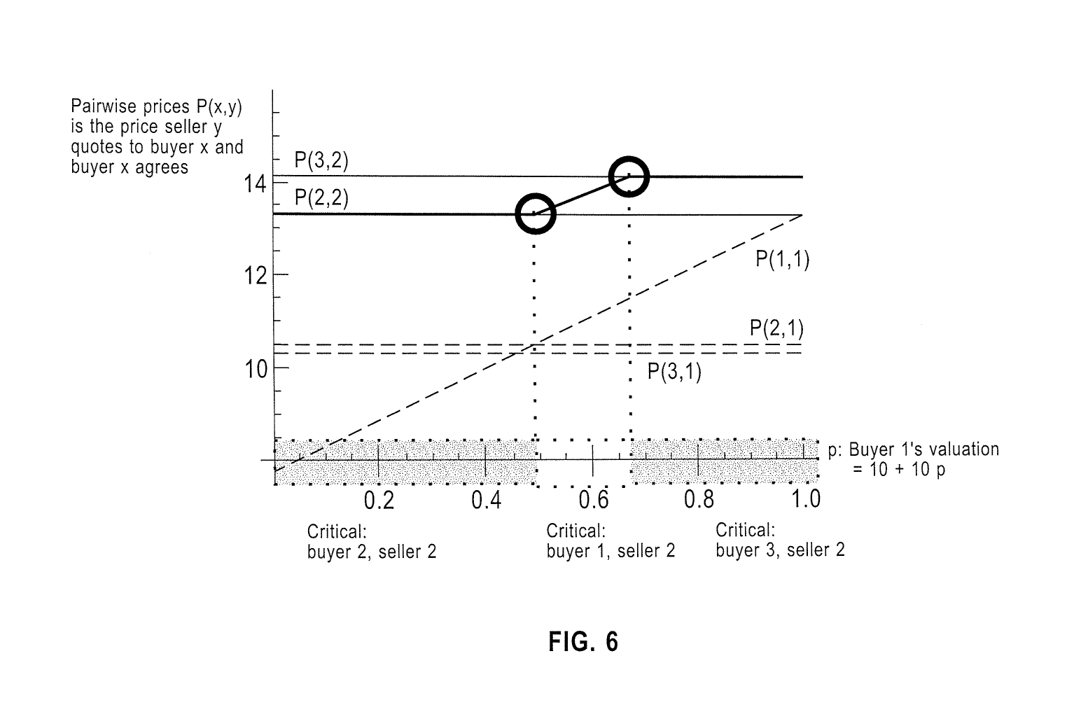

FIGS. 6 to 8 are exemplary graphs illustrating changes in the suggested bargaining terms likely to result in an agreeable outcome that are output in exemplary embodiments in response to a change in the attributes of a team member.

In the exemplary bargaining scenarios described with reference to FIGS. 6 to 8, the buying team includes three buyers (e.g., buyer 1, buyer 2, buyer 3) and the selling team includes three sellers (e.g., seller 1, seller 2, seller 3).

In FIG. 6, the graph illustrates a change in the generated suggested bargaining terms likely to result in an agreeable outcome in response to a change of a buyer's (e.g., buyer 1's) valuation score V, according to an exemplary embodiment. As shown in FIG. 6, the price weakly increases relative to valuations. When the uncertainty of the valuation scores V is defined by a probability distribution, exemplary embodiments of the present invention generate and output suggested bargaining terms corresponding to the distribution over prices at which an agreeable outcome may be reached. For example, for a desired success rate, which may be input to the bargaining determination system 100 via the input/output (I/O) interface 101 (see FIG. 1), referring to the sellers, the generated and output suggested bargaining terms correspond to the maximum price at which the current deal will be successful at the desired rate. Referring to the buyers, the generated and output suggested bargaining terms correspond to the minimum price at which the current deal will be successful at the desired rate.

Referring to FIG. 6, the buyers have respective valuation scores V of 10+10p, 15 and 20 (where p is a variable representing the uncertainty in the valuation score V of buyer 1), have respective patience scores δ of 0.8, 0.8 and 0.9, and each have a voting weight of 1 (resulting in a required majority of ⅔). The sellers have respective valuation scores V of 5, 12 and 21, have respective patience scores δ of 0.8, 0.7 and 0.8, and each have a voting weight of 1 (resulting in a required majority of ⅔). For example, pairwise prices P(x, y) represent an agreed-upon price that a seller y offers to buyer x (and which buyer x accepts). At a first transition point T1, buyer 1's valuation score V is high enough that buyer 1 is willing to pay a higher price than buyer 2. At this point, the selling team prefers reaching an agreement with the majority including buyer 1 and buyer 3, leaving buyer 2 out of the majority. At a second transition point T2, buyer 1's valuation score V increases to a point where buyer 3 no longer agrees to the price that is agreeable to buyer 1.

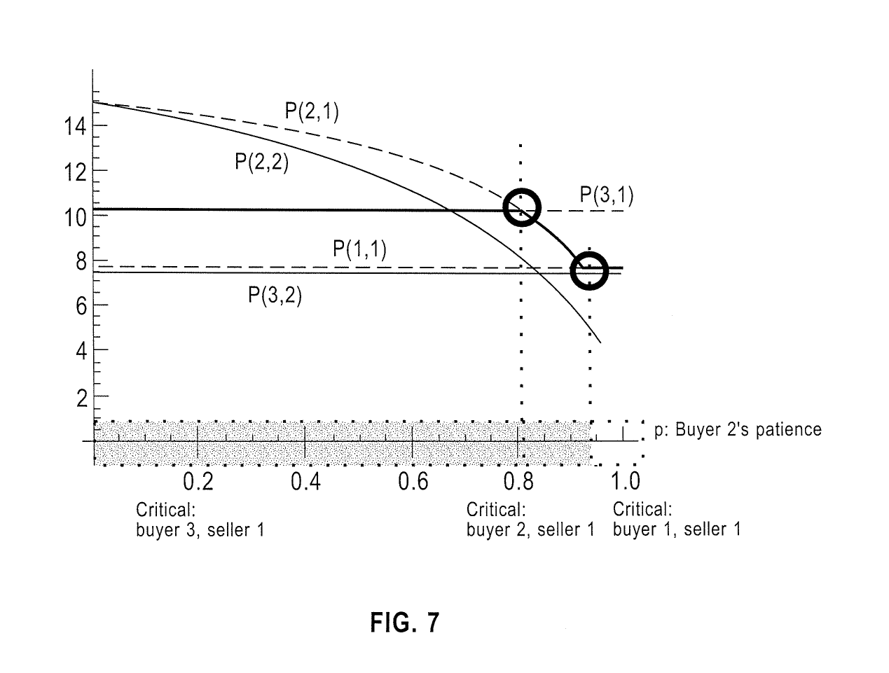

In FIG. 7, the graph illustrates a change in the generated suggested bargaining terms likely to result in an agreeable outcome in response to a change of a buyer's (e.g., buyer 2's) patience score δ, according to an exemplary embodiment. Referring to FIG. 7, the price weakly increases (or decreases) relative to a buyer's (or seller's) patience score δ. Referring to FIG. 7, the buyers have respective valuation scores V of 10, 15 and 20, have respective patience scores δ of 0.8, p and 0.9, and each have a voting weight of 1 (resulting in a required majority of ⅔). The sellers have respective valuation scores V of 5, 3 and 21, have respective patience scores δ of 0.8, 0.7 and 0.8, and each have a voting weight of 1 (resulting in a required majority of ⅔). For example, pairwise prices P(x, y) represent an agreed-upon price that a seller y offers to buyer x (and which buyer x accepts). At a first transition point T1, buyer 2's patience score δ is high enough that buyer 2 would rather wait than agree to the price offered to buyer 1. At a second transition point T2, buyer 2's patience is high enough that the sellers would rather reach an agreement with the majority including buyers 1 and 3, leaving buyer 2 out of the majority.

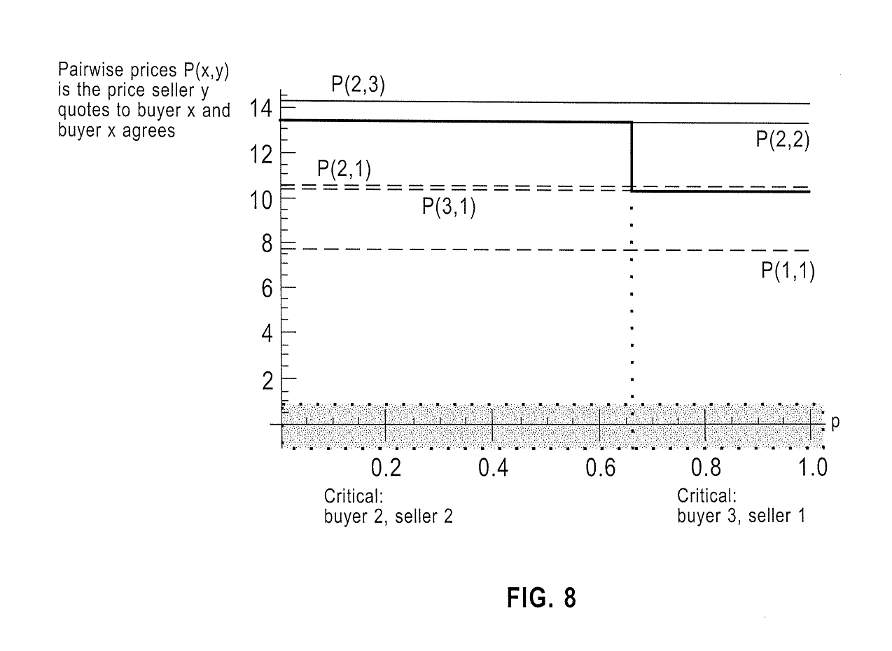

In FIG. 8, the graph illustrates a change in the generated suggested bargaining terms likely to result in an agreeable outcome in response to a change of voting weights, or the change of majority rule resulting in a change of the critical pair and prices. Referring to FIG. 8, the buyers have respective valuation scores V of 10, 15 and 20, have respective patience scores δ of 0.8, 0.8 and 0.9, and each have a voting weight of 1 (resulting in a required majority of ⅔). The sellers have respective valuation scores V of 5, 12 and 21, have respective patience scores δ of 0.8, 0.7 and 0.8, and have respective voting weights of 3p, 1 and 1 (where p is a variable representing the uncertainty in the voting weight of buyer 1). As a result, the required majority is ½ (e.g., {3p, 1, 1}/(2+3p)). In FIG. 8, pairwise prices P(x, y) represent an agreed-upon price that a seller y offers to buyer x (and which buyer x accepts). At a transition point T, seller 1 becomes a dictator, and therefore, becomes the critical seller.

According to exemplary embodiments of the present invention, a critical buyer x* and a critical seller y*are determined, and suggested bargaining terms (e.g., a suggested price) likely to result in an agreeable outcome during negotiations are generated and output based on the bilateral bargaining of the critical buyer x* and the critical seller y*. This process may result in increasing the efficiency and speed at which an agreeable outcome is reached between two teams during a bargaining process.

According to exemplary embodiments of the present invention, costless intra-team transfers are utilized to distribute a surplus within teams during a bargaining process, which may result in improved efficiency during the bargaining process. In an exemplary embodiment, an entirety of the surplus may be given to the team member having the highest patience.

In bargaining scenarios in which no intra-team transfers are present, critical buyers and sellers, as well as suggested bargaining terms likely to result in an agreeable outcome (e.g., a proposed price(s)) may be computed in O(n²) time when utilizing exemplary embodiments of the present invention. In bargaining scenarios in which intra-team transfers are present, critical buyers and sellers, as well as suggested bargaining terms likely to result in an agreeable outcome (e.g., a proposed price(s)) may be computed in O(n) time when utilizing exemplary embodiments of the present invention. Thus, according to exemplary embodiments, the computational complexity may be decreased, and performance may be improved.

Exemplary embodiments of the present invention may be utilized when negotiations regard payments that are dependent upon a future value (e.g., when the value of the deal is revealed some time in the future, or when there is uncertainty in the value of the deal).

It is to be understood that exemplary embodiments of the present invention may be implemented in various forms of hardware, software, firmware, special purpose processors, or a combination thereof. In one embodiment, a method for bargaining between teams with majority voting may be implemented in software as an application program tangibly embodied on a computer readable storage medium or computer program product. As such the application program is embodied on a non-transitory tangible media. The application program may be uploaded to, and executed by, a processor comprising any suitable architecture.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various exemplary embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

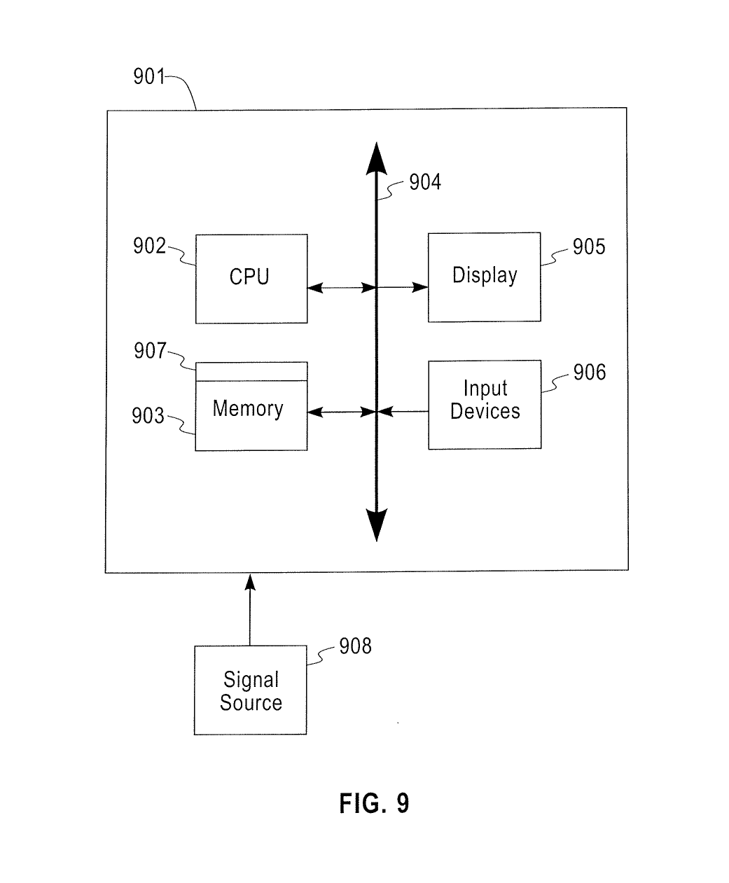

Referring to FIG. 9, according to an exemplary embodiment of the present invention, a computer system 901 for implementing aspects of the present invention can comprise, inter alia, a central processing unit (CPU) 902, a memory 903 and an input/output (I/O) interface 904. The computer system 901 is generally coupled through the I/O interface 904 to a display 905 and various input devices 906 such as a mouse and keyboard. The support circuits can include circuits such as cache, power supplies, clock circuits, and a communications bus. The memory 903 can include random access memory (RAM), read only memory (ROM), disk drive, tape drive, etc., or a combination thereof. The present invention can be implemented as a routine 907 that is stored in memory 903 and executed by the CPU 902 to process the signal from the signal source 908. As such, the computer system 901 is a general-purpose computer system that becomes a specific purpose computer system when executing the routine 907 of the present invention.

The computer platform 901 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described exemplary embodiments for a system and method for implementing a bargaining strategy between teams with majority voting, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and desired protected by Letters Patent is set forth in the appended claims.

What is claimed is:

1. A computer readable storage medium embodying instructions executed by a processor to perform a method of implementing a bargaining strategy, comprising:
receiving a first plurality of attributes corresponding to team members of a first team, and a second plurality of attributes corresponding to team members of a second team, wherein the first and second teams participate in a bargaining process and each team bargains pursuant to a majority rule;
determining at least one critical first team member from the first team using the first plurality of attributes, and at least one critical second team member from the second team using the second plurality of attributes, wherein the at least one critical first and second team members are determinative of an agreeable outcome of the bargaining process; and
generating suggested bargaining terms likely to result in the agreeable outcome of the bargaining process between the first and second teams according to the at least one critical first and second team members.

2. The computer readable storage medium of claim 1, wherein the first and second plurality of attributes comprise a valuation score representing an importance of reaching the agreeable outcome to each respective team member, a patience score representing a willingness of each respective team member to reach the agreeable outcome at a subsequent time, and a voting weight representing a voting influence of each respective team member during the bargaining process.

3. The computer readable storage medium of claim 2, wherein a sum of the voting weights for each team is one.

4. The computer readable storage medium of claim 2 wherein the suggested bargaining terms are agreeable to the critical first and second team members, and are not agreeable to an entirety of team members of the first and second teams.

5. The computer readable storage medium of claim 2, further comprising:
simulating a bargaining process between only the at least one critical first and second team members, wherein generating the suggested bargaining terms likely to result in the agreeable outcome of the bargaining process between the first and second teams is based on a simulated result of the simulated bargaining process.

6. The computer readable storage medium of claim 2, wherein the first team comprises a team of buyers of a product or a service, and the second team comprises a team of sellers of the product or the service.

7. The computer readable storage medium of claim 6, wherein the generated suggested bargaining terms comprise a suggested price of the product or service likely to result in the agreeable outcome between the first and second teams.

8. The computer readable storage medium of claim 7, further comprising:
generating a first price matrix indicating a maximum price of the product or service acceptable to each buyer of the first team relative to each seller of the second team;
generating a second price matrix indicating a minimum price of the product or service acceptable to each seller of the second team relative to each buyer of the first team;
generating a potential critical seller list by determining a lowest price resulting in a weighted majority of approval of sellers of the second team for each row in the first price matrix;
generating a potential critical buyer list by determining a highest price resulting in a weighted majority of approval of buyers of the first team for each column in the second price matrix;
selecting the at least one critical first and second team members based on a comparison of the potential critical buyers and the potential critical sellers; and
generating the suggested bargaining terms according to the selected at least one critical first and second team members.

9. The computer readable storage medium of claim 8, wherein the suggested bargaining terms comprise a final maximum price likely to result in the agreeable outcome between the first and second teams, and a final minimum price likely to result in the agreeable outcome between the first and second teams.

10. The computer readable storage medium of claim 2, wherein the majority rule of the first and second teams is different.

11. The computer readable storage medium of claim 2, wherein the majority rule of at least one of the first and second teams requires unanimity.

12. The computer readable storage medium of claim 2, further comprising:
determining a surplus within at least one of the first and second teams when intra-team transfers are permitted within the at least one of the first and second teams; and
distributing the surplus among at least two team members of the at least one of the first and second teams.

13. The computer readable storage medium of claim 12, wherein an entirety of the surplus is given to a single team member of the at least one of the first and second teams, wherein the single team member has a highest patience score among the team members of the at least one of the first and second teams.

14. A computer readable storage medium embodying instructions executed by a processor to perform a method of implementing a bargaining strategy, comprising:
receiving a first plurality of attributes corresponding to team members of a first team, and a second plurality of attributes corresponding to team members of a second team, wherein the first and second teams participate in a bargaining process and each team bargains pursuant to a majority rule;
generating at least one simulated critical first team member corresponding to the first team based on a weighted average of a first attribute from among the first plurality of attributes of every team member of the first team;
generating at least one simulated critical second team member corresponding to the second team based on a weighted average of a first attribute from among the second plurality of attributes of every team member of the second team, wherein the at least one simulated critical first and second team members are determinative of an agreeable outcome of the bargaining process; and
generating suggested bargaining terms likely to result in the agreeable outcome of the bargaining process between the first and second teams according to the at least one simulated critical first and second team members.

15. The computer readable storage medium of claim 14, wherein the first and second plurality of attributes comprise a valuation score representing an importance of reaching the agreeable outcome to each respective team member, a patience score representing a willingness of each respective team member to reach the agreeable outcome at a subsequent time, and a voting weight representing a voting influence of each respective team member during the bargaining process.

16. The computer readable storage medium of claim 15, wherein the suggested bargaining terms are agreeable to the simulated critical first and second team members, and are not agreeable to an entirety of team members of the first and second teams.

17. The computer readable storage medium of claim 15, further comprising:
simulating a bargaining process between only the at least one simulated critical first and second team members, wherein generating the suggested bargaining terms likely to result in the agreeable outcome of the bargaining process between the first and second teams is based on a simulated result of the simulated bargaining process.

18. The computer readable storage medium of claim 15, wherein the first team comprises a team of buyers of a product or a service, and the second team comprises a team of sellers of the product or the service.

19. The computer readable storage medium of claim 18, wherein the generated suggested bargaining terms comprise a suggested price of the product or service likely to result in the agreeable outcome between the first and second teams.

20. A computer readable storage medium embodying instructions executed by a processor to perform a method of implementing a bargaining strategy, comprising:
receiving a first plurality of attributes corresponding to team members of a first team, and a second plurality of attributes corresponding to team members of a second team, wherein the first and second teams participate in a bargaining process and each team bargains pursuant to a majority rule;
generating a first price matrix indicating a maximum value acceptable to each team member of the first team relative to each team member of the second team;
generating a second price matrix indicating a minimum value acceptable to each team member of the second team relative to each team member of the first team;
generating a potential first critical team member list, comprising a plurality of potential first critical team members, by determining a highest price resulting in a weighted majority of approval of the team members of the first team for each column in the second price matrix;
generating a potential second critical team member list, comprising a plurality of potential second critical team members, by determining a lowest value resulting in a weighted majority of approval of the team members of the second team for each row in the first price matrix;
selecting at least one first critical team member from among the plurality of first potential critical team members, and at least one second critical team member from among the plurality of second potential critical team members, based on a comparison of the potential first critical team members and the potential second critical team members, wherein the at least one first and second critical team members are determinative of an agreeable outcome of the bargaining process; and
generating suggested bargaining terms according to the selected at least one first and second critical team members likely to result in the agreeable outcome of the bargaining process.

21. The computer readable storage medium of claim 20, wherein the first and second plurality of attributes comprise a valuation score representing an importance of reaching the agreeable outcome to each respective team member, a patience score representing a willingness of each respective team member to reach the agreeable outcome at a subsequent time, and a voting weight representing a voting influence of each respective team member during the bargaining process.
